(19) United States
(12) Patent Application Publication
(10) Pub. No.: US 2004/0019475 A1
(43) Pub. Date: Jan. 29, 2004

(54) Musical chord change detector and indicator

(76) Inventors: John Donald Bloom, Bend, OR (US); Thomas Everett O'Neal, Bend, OR (US)

Correspondence Address: GLENN C. BROWN, PC, 777 NW WALL STREET, SUITE 308, BEND, OR, 97701, US

(21) Appl. No.: 10/140,525

(22) Filed: May 6, 2002

(51) Int. Cl. G09B 15/02

(52) U.S. Cl. 704/1; 84/477 R

(57) ABSTRACT

TABLE 1

| Named Note | EQ Freq | Named Note | EQ Freq |
|---|---|---|---|
| D1 | 37.71 | E4 | 329.6 |
| E_{b}1 | 38.9 | F4 | 349.2 |
| E1 | 41.2 | G_{b}4 | 370 |
| F1 | 43.65 | G4 | 392 |
| G_{b}1 | 46.25 | A_{b}4 | 415.3 |
| G₁ | 49 | A4 | 440 |
| A_{b}1 | 51.9 | B_{b}4 | 466.2 |
| A1 | 55 | B4 | 493.9 |
| B_{b}1 | 58.2 | C5 | 523.3 |
| B1 | 61.7 | D_{b}5 | 554.4 |
| C1 | 65.4 | D5 | 587.3 |
| D_{b}1 | 69.3 | E_{b}5 | 622.3 |
| D2 | 73.42 | E5 | 659.3 |
| E_{b}2 | 77.8 | F5 | 698.5 |
| E2 | 82.41 | G_{b}5 | 740 |
| F2 | 87.31 | G5 | 784 |
| G_{b}2 | 92.5 | A_{b}5 | 830.6 |
| G2 | 98 | A5 | 880 |
| A_{b}2 | 103.8 | B_{b}5 | 932.3 |
| A2 | 110 | B5 | 987.8 |
| B_{b}2 | 116.5 | C6 | 1047 |
| B2 | 123.5 | D_{b}6 | 1109 |
| C3 | 130.8 | D6 | 1175 |
| D_{b}3 | 138.6 | E_{b}6 | 1245 |
| D3 | 146.8 | E6 | 1319 |
| E_{b}3 | 155.6 | F6 | 1397 |
| E3 | 164.8 | G_{b}6 | 1480 |
| F3 | 174.6 | G6 | 1568 |
| G_{b}3 | 185 | A_{b}6 | 1661 |
| G3 | 196 | A6 | 1760 |
| A_{b}3 | 207.7 | B_{b}6 | 1865 |
| A3 | 220 | B6 | 1976 |
| B_{b}3 | 233.1 | C6 | 2094 |
| B3 | 246.9 | D_{b}6 | 2218 |
| C4 | 261.6 | | |
| D_{b}4 | 277.2 | | |
| D4 | 293.7 | | |
| E_{b}4 | 311.1 | | |

### BACKGROUND OF THE INVENTION

This invention relates to devices that provide a visual or audio cue to musical chord changes. Many musical groups often rely on some sort of cue from a knowledgeable player to signal chord changes to one or more other members of the group. In many instances, a simple, prearranged hand signal or other physical signal is sufficient. In other instances, a device such as a wobble pedal is utilized. A wobble pedal is a multi-position switch that can be manipulated by a user's foot to one of multiple positions. Each position transmits a signal that lights an indicator light for a specific chord. A chord change is signaled by manipulating the switch to indicate the desired chord. While this method is useful and does work, it is less than ideal in that it requires a player to be close to the wobble pedal at the time of the chord change, and requires the attention of that player. A need therefore exists for a new and improved method of signaling chord changes to band members that overcomes the shortcomings of the prior art.

### SUMMARY OF THE INVENTION

The invention is embodied in an apparatus that detects musical notes being played by a lead player, and then compares the detected combinations of musical notes with a data base of musical chords characterized by specific combinations of notes. If the detected notes correspond to a chord included in the data base, the device provides a visual or audio cue of the chord change to one or more players accompanying the lead player. It will also sense and establish the tempo so that chord changes can occur in time with that of the lead player.

### BRIEF DESCRIPTION OF THE DRAWINGS

FIG. 1 is a block diagram of one preferred embodiment of the invention.

### DETAILED DESCRIPTION OF THE PREFERRED EMBODIMENTS

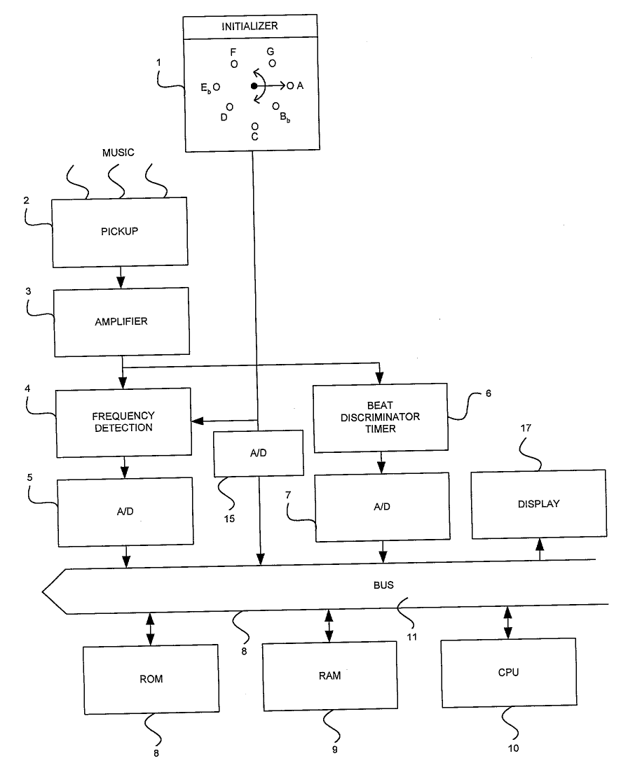

Referring to FIG. 1, preferred embodiments of the invention will be described in greater detail, and then by describing how the invention would be used by a musical group.

An apparatus according to the preferred embodiment includes an initializer 1, a frequency detector 4, a beat discriminator timer 6, a read only memory 8, a random access memory 9, a display 17, and a CPU 10. The frequency detector 4, a beat discriminator timer 6, a read only memory 8, a random access memory 9, a display 17, and a CPU 10 communicate through bus 11. A/D converters 5, 7 and 15 are positioned between bus 11 and respective frequency detector 4, initializer 1 and beat discriminator timer 6. A music pickup 2 and amplifier 3 receive and pass musical signals to the frequency detector and beat discriminator timer 6. Initializer 1 is shown in FIG. 1 as a rotary switch, and could also be a foot operated switch, or a switch of any suitable design that can be set to multiple positions. The frequency detector 4 is preferably a scanning filter that receives a plurality of notes being played by the lead player, and by progressively filtering specific frequencies identifies the individual note being played by the lead player.

In another embodiment, the frequency detector has a second mode of operation in which it is used to tune the instrument of the lead player (or other players) to assure correspondence of the notes being played by the lead player with the frequencies residing in the database, and which are used by the CPU to identify chord changes. In this mode of operation ROM 8 includes a tuning database populated with the specific frequencies for a 7 octave range of notes, e.g., 36.71 to 2350 Hz. See Table 1. When the player tunes his instrument, the frequency detector receives the note and outputs a frequency value in the form of a digital signal to the CPU. The CPU compares the frequency received with the tuning database, and if the player is within a prescribed tolerance, which may vary along the frequency range, the CPU signals the display to display the note played.

Display 17 preferably includes lights or LED's that can transmit the chord character designations directly. By way of example, the display in one embodiment includes a panel of LED's that can be selectively illuminated to indicate chord-indicating characters directly to the viewer. In alternate embodiments, the display could utilize multiple colored lights, each of which represents a particular chord in a given musical key.

Various accompanying instruments in a musical group are required to change chords throughout the course of a musical piece. In instances where the person playing an accompanying instrument cannot identify the onset of the required chord change, this invention provides a visual or audio cue to the player indicating the new chord. Initializer 1 is positioned near a player of the group who would be responsible for setting the initializer 1 to the correct key at the beginning of the song. Alternatively, the apparatus can display the initial chord after identifying the chord from the early notes of the song. One or more displays 17 would be placed near other members of the group. In the instance of the first embodiment utilizing LED's, once the initializer 1 is set, the selected key and initial chord are temporarily stored in RAM 9, and are also displayed on the display 17. As the musical piece progresses, frequency detector 4 receives and identifies the note or notes being played by the players. The identified chord is stored temporarily in RAM 9. The CPU 10 continually compares the notes being played by the players with a data base residing in ROM 8, and as long as the notes being played correspond to the chord being displayed, the display 17 continues to display that chord.

The data base stored in ROM 8 is populated with a number of two and three note combinations that are uniquely characteristic of chords within particular musical keys. In one preferred hierarchy of data within the ROM, the data is organized into keys, and within the sub data base for each key are the possible combinations of two notes which in each key, uniquely identify each chord available in that musical key. For example, if the lead player has specified the key of D for the song, initializer 1 is set to the key of D, and in one embodiment the initial backup chord is selected and displayed by the CPU on the display 17. In this example, the chord of D is initially specified. The CPU 10 continually monitors the notes being played through frequency detector 4. So long as the notes played are consistent with a D chord, the display is not changed. However, when a required chord change occurs, the different notes are detected by the frequency detector 4 and transmitted to the RAM 9. CPU 10 compares the newly received notes from the frequency detector 4 and compares them with the data base of notes residing in ROM 8.

The CPU identifies the new chord, for example G, by comparing the notes received with the data base of note combinations, and determines whether either of the other chords in the key of D includes any two note combination now detected in the notes being played. For example, if the CPU identifies a two note combination that is uniquely characteristic of the chord of G, the CPU transmits a signal to the display 17 to indicate the chord G. This process is repeated throughout the musical piece, and as chord changes are detected they are displayed to the players.

The identification of the chords being played is achieved by taking advantage of the fact that each chord consists of unique combinations of individual notes, and further that certain combinations of two individual notes are characteristic of only one chord, regardless of the particular musical key.

By way of background, the following summary of the relationship of keys and the chords therein is provided. The available musical chords in any particular key are as follows:

Tonic, Tonic Major, Tonic Minor, Tonic Augmented, Tonic Diminished, Tonic Major 6, Tonic Major 7, Tonic Major 9, Tonic Minor 6, Tonic Minor 7, Tonic Minor 9, Tonic Dominant 7, Tonic Dominant 9, Tonic Dominant 11, Tonic Dominant 13, and Tonic Dim. 7. The chords most often used by string bands for example are the Tonic Major, Dominant 7, and Subdominant chords.

Primarily, simple musical songs are written using the chords—Tonic (key), Doninate 7, and Subdominate. These chords are used in rhythmic accompaniment. Occasionally, other chords are used for good accompaniment.

There are twelve (12) notes to an octave. For example, using Tonic A

| A | | B_{b} | | B | | C | | C# | | D | | E_{b} | | E | | F | | G_{b} | | G | | A_{b} | | | | |
|---|---|---|---|---|---|---|---|---|---|---|---|---|---|---|---|---|---|---|---|---|---|---|---|---|---|---|
| | - | | - | | - | | - | | - | | - | | - | | - | | - | | - | | - | | - - - | A | B_{b} | B |
| 1 | | 2 | | 3 | | 4 | | 5 | | 6 | | 7 | | 8 | | 9 | | 10 | | 11 | | 12 | | | | |

The next octave repeats the above sequence, but the frequencies are higher. Chords are formed using combinations of the notes.

A Diatonic Scale is a series of eight successive notes. The first and eighth notes have the same name, but the eighth note is at twice the frequency of the first. Using numerals for designators, scales appear thusly: (Half notes occur between 3 and 4 and 7 and 8).

| 1 | 2 | 3 | 4 | 5 | 6 | 7 | | 8 |
|---|---|---|---|---|---|---|---|---|
| A | B | C# | D | E | F# | G#(A_{b}) | — | A |
| B_{b} | C | D | E_{b} | F | G | A | — | B_{b} |
| C | D | F | F | G | A | B | — | C |
| D | E | F# | G | A | B | C# | — | D |
| E_{b} | F | G | A_{b} | B_{b} | C | D | — | E_{b} |
| F | G | A | B_{b} | C | D | E | — | F |
| G | A | B | C | D | E | F# | — | G |

Chords are formed with two or more notes, all played simultaneously. Major chords are formed by playing notes 1, 3, and 5 simultaneously as shown below:

| Chord | 1 | 3 | 5 |
|---|---|---|---|
| A | A | C# | E |
| B_{b} | B_{b} | D | F |
| C | C | E | G |
| D | D | F# | A |
| E_{b} | E_{b} | G | B_{b} |
| F | F | A | C |
| G | G | B | D |

The basic chords played in rhythmic accompaniment are 1, IV, and V, shown in bold below:

| I | II | III | IV | V | VI | VII |
|---|---|---|---|---|---|---|
| A | B | C | D | E | F | G |
| B_{b} | C | D | E_{b} | F | G | A |
| C | D | E | F | G | A | B |
| D | E | F | G | A | B | C |
| E_{b} | F | G | A_{b} | B_{b} | C | D |
| F | G | A | B_{b} | C | D | E |
| G | A | B | C | D | E | F |

In the table above, chord I is the key chord in which the song is written, chord IV is the key's subdominant chord, and chord V is the key's dominant chord designated as the 7^{th} (i.e, D7, A7, etc.).

A limited listing of dominant chords, which are formed using four (4) notes, is shown in the following chart.

| | | | | |
|---|---|---|---|---|
| A7 | A | C# | E | G |
| B_{b}7 | B_{b} | D | F | A_{b} |
| C7 | C | E | G | B_{b} |
| D7 | D | F | A | C |
| E_{b}7 | E_{b} | G | B_{b} | D_{b} |
| F7 | F | A | C | E_{b} |
| G7 | G | B | D | F |

In the present invention, recall that the CPU, in conjunction with the frequency detector, RAM and ROM, continually samples the music being played to determine whether a chord change has been initiated. It does so by continually sampling for unique 2-note combinations that are characteristic of particular chords, and when one such combination is detected, signals the chord change through the display 17. The following is a listing of 2-note combinations that uniquely characterize the indicated chords. These 2-note combinations populate a data base fixed in ROM 9, and against which the sampled music is compared by the CPU to idendify the chord change.

| Chord | | Chord Notes | Two Note Selection | | |
|---|---|---|---|---|---|
| A | — | AC# E | AC# | AE | C#E |
| B_{b} | — | B_{b}DF | B_{b}D | B_{b}F | DF |
| C | — | CEG | CE | CG | EG |
| D | — | DF#A | DF# | F#A | DA |
| E_{b} | — | E_{b}GB_{b} | E_{b}G | GB_{b} | E_{b}B_{b} |
| F | — | FAC | FA | AC | RC |
| G | — | GBD | GB | GD | BD |
| A7 | — | AC#EG | AG | C#G | |
| B_{b}7 | — | B_{b}DFA_{b} | B_{b}A_{b} | DA_{b} | FA_{b} |
| C7 | — | CEGB_{b} | CB_{b} | EB_{b} | GB_{b} |
| D7 | — | DF#AC | DC | F#C | |
| E_{b}7 | — | E_{b}GB_{b}D_{b} | E_{b}D_{b} | GD_{b} | B_{b}D_{b} |
| F7 | — | FACE_{b} | FE_{b} | AE_{b} | CE_{b} |
| G7 | — | GBDF | GF | BF | DE |

While a limited number of keys and chords are shown above for purposes of illustration, the invention is not limited to any particular keys or chords. Those skilled in the art will recognize that at least one two-note combination uniquely identifies each of the 15 or more chords within each of the 12 major keys. The embodiments above are illustrative and are not intended to exclude non-illustrated major keys and associated chords.

In conjunction with the frequency detector 4, the beat discriminator 6 continually monitors the timing of the notes being played. CPU 10 transmits a signal to display 17 conveying to the accompanying players the proper timing of the notes (4/4, 3/4, etc). Initializer 1 can also include a mechanism for presetting the meter. In another embodiment the beat discriminator also includes a metronomic component that continually monitors the meter or tempo of the song, and indicates variations detected by the beat discriminator. In another embodiment, the beat discriminator can respond to a detected change in meter and display the change on display 17.

In other embodiments, the visual display is replaced by an audio processor that transmits the chord and meter information audibly to the accompanying player. The audio processor can use synthesized voice technology, or any other audio signal generator that can be triggered by the CPU.

While the invention has been described by reference to preferred embodiments of the invention, those skilled in the art will recognize that numerous changes in detail can be made without departing from the scope of the following claims.

What is claimed is:

1. A musical note and chord detector and indicator comprising:
a detector operable to generate a note-identifying signal responsive to each of a plurality of predetermined musical notes;
a processor in communication with the detector and operable to identify a musical chord and to generate a chord signal responsive at least one note-identifying signal from the detector; and,
a visual display in communication with the processor and operable to visually indicate a chord responsive to the chord signal generated by the processor.

2. A musical note and chord detector according to claim 1 further comprising:
a data base of musical note combinations characteristic of each of a plurality of musical chords; and
the processor in communication with the data base.

3. A musical note and chord detector according to claim 2 further wherein the musical note combinations characteristic of each of a plurality of musical chords includes a plurality of two note combinations, each two note combination uniquely characteristic of a single chord within a particular musical key.

4. A musical note and chord detector and indicator comprising:
a detector operable to generate a note-identifying signal responsive to each of a plurality of predetermined musical notes;
a processor in communication with the detector and operable to identify a musical chord and to generate a chord signal responsive at least one note-identifying signal from the detector; and
an audio signal generator in communication with the processor and operable to audibly indicate a chord responsive to the chord signal generated by the processor.

5. A musical note and chord detector according to claim 4 further comprising:
a data base of musical note combinations characteristic of each of a plurality of musical chords; and,
the processor in communication with the data base.

6. A musical note and chord detector according to claim 5 further wherein the musical note combinations characteristic of each of a plurality of musical chords includes a plurality of two note combinations, each two note combination uniquely characteristic of a single chord within a particular musical key.

7. A musical note and chord detector according to claim 3 wherein the chord is A and the two note combination is selected from the group consisting of AC#, AE, and C#E.

8. A musical note and chord detector according to claim 3 wherein the chord is B_{b} and the two note combination is selected from the group consisting of B_{b}D, B_{b}F, and DF.

9. A musical note and chord detector according to claim 3 wherein the chord is C and the two note combination is selected from the group consisting of CE, CG, and EG.

10. A musical note and chord detector according to claim 3 wherein the chord is D and the two note combination is selected from the group consisting of DF#, F#A, and DA.

11. A musical note and chord detector according to claim 3 wherein the chord is E_{b} and the two note combination is selected from the group consisting of E_{b}C, GB_{b}, and E_{b}B_{b}.

12. A musical note and chord detector according to claim 3 wherein the chord is F and the two note combination is selected from the group consisting of FA, AC, and FC.

13. A musical note and chord detector according to claim 3 wherein the chord is G and the two note combination is selected from the group consisting of GB, GD, and BD.

14. A musical note and chord detector according to claim 3 wherein the chord is A7 and the two note combination is selected from the group consisting of AG and C#G.

15. A musical note and chord detector according to claim 3 wherein the chord is B_{b}7 and the two note combination is selected from the group consisting of B_{b}A_{b}, DA_{b}, and FA_{b}.

16. A musical note and chord detector according to claim 3 wherein the chord is C7 and the two note combination is selected from the group consisting of CB_{b}, EB_{b}, and CB_{b}.

17. A musical note and chord detector according to claim 3 wherein the chord is D7 and the two note combination is selected from the group consisting of DC and F#C.

18. A musical note and chord detector according to claim 3 wherein the chord is E_{b}7 and the two note combination is selected from the group consisting of E_{b}D_{b}, GD_{b}, and B_{b}D_{b}.

19. A musical note and chord detector according to claim 3 wherein the chord is F7 and the two note combination is selected from the group consisting of FE_{b}, AE_{b}, and CE_{b}.

20. A musical note and chord detector according to claim 3 wherein the chord is G7 and the two note combination is selected from the group consisting of GF, BF, and DF.

21. A musical note and chord detector according to claim 5 wherein the chord is A and the two note combination is selected from the group consisting of AC#, AE, and C#E.

22. A musical note and chord detector according to claim 5 wherein the chord is B_{b} and the two note combination is selected from the group consisting of B_{b}D, B_{b}F, and DF.

23. A musical note and chord detector according to claim 5 wherein the chord is C and the two note combination is selected from the group consisting of CE, CG, and EG.

24. A musical note and chord detector according to claim 5 wherein the chord is D and the two note combination is selected from the group consisting of DF#, F#A, and DA.

25. A musical note and chord detector according to claim 5 wherein the chord is E_{b} and the two note combination is selected from the group consisting of E_{b}G, GB_{b}, and E_{b}B_{b}.

26. A musical note and chord detector according to claim 5 wherein the chord is F and the two note combination is selected from the group consisting of FA, AC, and FC.

27. A musical note and chord detector according to claim 5 wherein the chord is G and the two note combination is selected from the group consisting of GB, GD, and BD.

28. A musical note and chord detector according to claim 5 wherein the chord is A7 and the two note combination is selected from the group consisting of AG and C#G.

29. A musical note and chord detector according to claim 5 wherein the chord is B_{b}7 and the two note combination is selected from the group consisting of B_{b}A_{b}, DA_{b}, and FA_{b}.

30. A musical note and chord detector according to claim 5 wherein the chord is C7 and the two note combination is selected from the group consisting of CB_{b}, EB_{b}, and GB_{b}.

31. A musical note and chord detector according to claim 5 wherein the chord is D7 and the two note combination is selected from the group consisting of DC and F#C.

32. A musical note and chord detector according to claim 5 wherein the chord is E_{b}7 and the two note combination is selected from the group consisting of E_{b}D_{b}, D_{b}, and B_{b}D_{b}.

33. A musical note and chord detector according to claim 5 wherein the chord is F7 and the two note combination is selected from the group consisting of FE_{b}, AE_{b}, and CE_{b}.

34. A musical note and chord detector according to claim 5 wherein the cord is G7 and the two note combination is selected from the group consisting of GF, BF, and DF.
